(19) United States
(12) Patent Application Publication
(10) Pub. No.: US 2008/0154782 A1
(43) Pub. Date: Jun. 26, 2008

(54) APPARATUS, METHOD AND SYSTEM FOR PROTECTING PERSONAL INFORMATION

(75) Inventors: Bo-gyeong KANG, Seoul (KR); Seung-chul Chae, Suwon-si (KR); Yeong-mok You, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/833,455

(22) Filed: Aug. 3, 2007

(30) Foreign Application Priority Data
Dec. 22, 2006 (KR) 2006-132969

(51) Int. Cl. H04L 9/30; H04K 1/00; H04L 9/00

(52) U.S. Cl. 705/74; 380/44

(57) ABSTRACT

A method, apparatus, and system for protecting personal information are provided. The personal-information-protecting apparatus is a device for protecting personal information using a pseudonym, and includes a pseudonym-generating unit that generates a pseudonym, a pseudo-public key corresponding to the pseudonym, and a pseudo-secret key, and a verifying unit that verifies that the pseudonym included in a rights object is identical to one of the generated pseudonyms. The device stores and manages metering data and billing information. The system includes a device, a rights issuer, and at least one of a pseudonym credential issuer and a paying center.

### CROSS-REFERENCE TO RELATED APPLICATION

This application claims the benefit of Korean Patent Application No. 2006-132969, filed Dec. 22, 2006 in the Korean Intellectual Property Office, the disclosure of which is incorporated herein in its entirety by reference.

### BACKGROUND OF THE INVENTION

1. Field of the Invention

Aspects of the present invention relate to an apparatus and method to protect personal information, and more particularly to a method and apparatus to protect personal information with regard to billing and content use via a pseudonym.

2. Description of the Related Art

The growth of the Internet and the development of multimedia technology have led to a widespread distribution and accessibility of digital content. However, if there is no viable way to protect the rights of such digital content, the development of multimedia technology would also lead to unauthorized distribution of the digital content. Accordingly, digital rights management (hereinafter referred to as “DRM”) has been introduced as content-protecting technology that protects rights of a digital content user and prevents illegal distribution.

Methods of maintaining user anonymity and transaction privacy have been introduced. Korean Unexamined Patent No. 2005-0085233 (U.S. Patent Publication No. 2004/0128259) discloses a system for conducting electronic transactions with a potentially untrustworthy server while maintaining user anonymity and transaction privacy and allowing the server to verify that the user is a valid subscriber entitled to participate in the transaction.

FIG. 1 depicts a process where a device requests a rights issuer to register its ID in a conventional DRM system. A conventional DRM system includes a device, a rights issuer, and an online certificate status protocol responder (OCSP responder). The device, which consumes or utilizes the content, includes a DRM agent that can receive and use a rights object. The rights object includes information on permissions and constraints, which is configured with an encryption key to encrypt the content, and an object including a signature of the rights issuer. The rights issuer checks the device ID (a unique ID) and decrypts the content of the device ID using a public key corresponding to the device ID. The rights issuer issues the rights object including the public key. The OSCP responder checks the validity of the device and the rights issuer in real time.

The device and the rights issuer authenticate each other using their allocated IDs, and exchange public key information (12). The device requests the rights issuer to register the device ID (14). Then, the rights issuer requests the OSCP responder to check whether the device is valid (16). The OSCP responder transmits a response message to the rights issuer in response to the request of the rights issuer (18). If the device is valid, the rights issuer stores information related to the device and transmits a response message for the registration request to the device (20). The information related with the device includes the device ID and the public key information. The registered device can request a rights object corresponding to predetermined content from the rights issuer.

FIG. 2 depicts a process where a device obtains a rights object according to the related art. When the registered device requests a rights object for a predetermined content from the rights issuer, the rights issuer requests the OCSP responder to verify the validity of the device (22 and 24). Then, the OSCP responder transmits a response message to the rights issuer (26). If the device that requests the rights object is valid, the rights issuer generates a rights object bound to the device ID and transmits the rights object bound to the device ID to the device (28). That is, the rights object includes the device ID and information that enables decryption of content that is encrypted by a public key corresponding to the device ID and transmitted to the device. The device verifies the device ID included in the transmitted rights object (28). The device can use the rights object via the DRM agent.

If a metering service is added in the above processes, the device reports the content use for its ID. The rights issuer or metering service provider collects and manages metering data according to the registered device IDs or users. The collected metering data can be data that enables calculation of a payment for the content use.

However, the conventional DRM system is problematic in that information regarding content type used by a device is concentrated and managed by the rights issuer because a rights object corresponding to the device ID is generated. Also, the DRM system that uses the metering service may expose a user's tendencies, such as content use, which may violate privacy rights of the user.

### SUMMARY OF THE INVENTION

In view of the above, aspects of the present invention provide an apparatus and method for protecting personal information associated with content use using a pseudonym, which can prevent exposure of the personal information.

According to an aspect of the present invention, there is provided a personal-information-protecting apparatus corresponding to a device to protect personal information, the apparatus including a pseudonym-generating unit that generates a pseudonym to blind an ID of the device using content, a pseudo-public key, and a pseudo-secret key both of which correspond to the pseudonym, and a verifying unit that verifies whether a pseudonym included in the rights object is identical to the pseudonym so as to selectively enable the device to use the content consistent with the rights indicated in the rights object.

According to an aspect of the present invention, there is provided a personal-information-protecting method including generating a pseudonym to blind and ID of the device using content, a pseudo-public key, and a pseudo-secret key, both of which correspond to the pseudonym and verifying whether a pseudonym included in a rights object is identical to one of the generated pseudonyms so as to selectively allow use of the contents according to rights indicated in the rights object.

According to an aspect of the present invention, there is provided a system for protecting personal information including a device that uses content and generates a pseudonym to mask an ID of the device, a pseudo-public key, and a pseudo-secret key; a rights issuer to generate a rights object including information that enables the device to use the content; and at least one of a pseudonym credential issuer and a paying center, wherein, if the system includes the pseudonym credential issuer, the device generates a signature value from the pseudonym and the pseudo-public key, the pseudonym credential issuer verifies the signature value, and the rights issuer transmits the rights object to the device according to the verified signature, and if the system includes the paying center, the device transmits a metering data to the rights issuer, the rights issuer transmits billing information to the device in response thereto, the device transmits the billing information to the paying center that certifies a payment, and the device requests the rights object from the rights issuer according to the certified payment.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 depicts a process where a device requests a rights issuer to register its ID in a conventional DRM system;

FIG. 2 depicts a process where a device obtains a rights object according to the conventional art;

FIG. 3 is a block diagram of a personal-information-protecting apparatus according to aspects of the present invention;

FIGS. 4 and 5 depict a process of issuing a rights object according to aspects of the present invention;

FIGS. 6 and 7 depict a process of initializing metering data and billing information according to aspects of the present invention.

FIG. 8 depicts the structure of a rights object bound to a pseudonym according to aspects of the present invention.

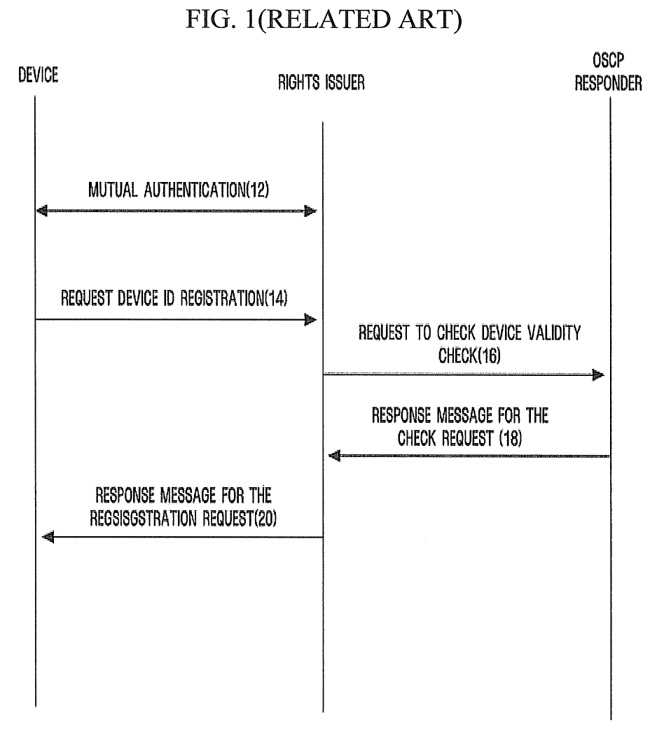

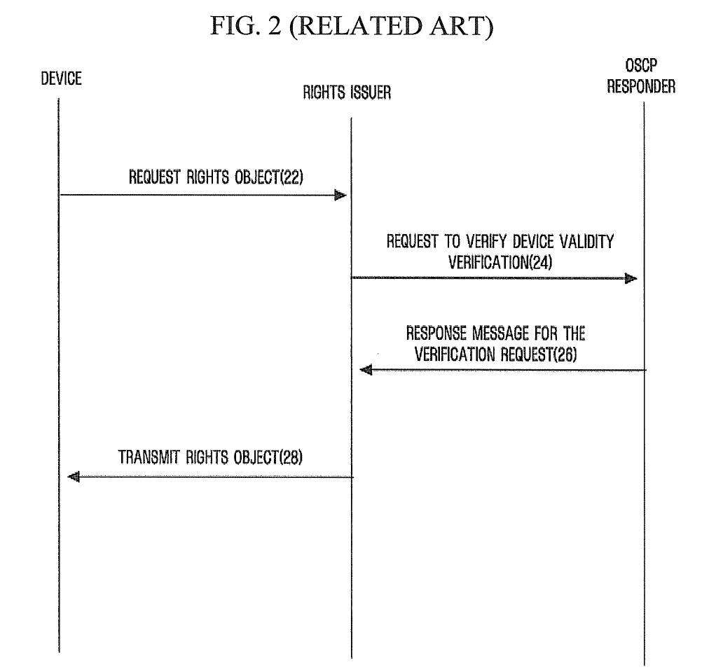

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

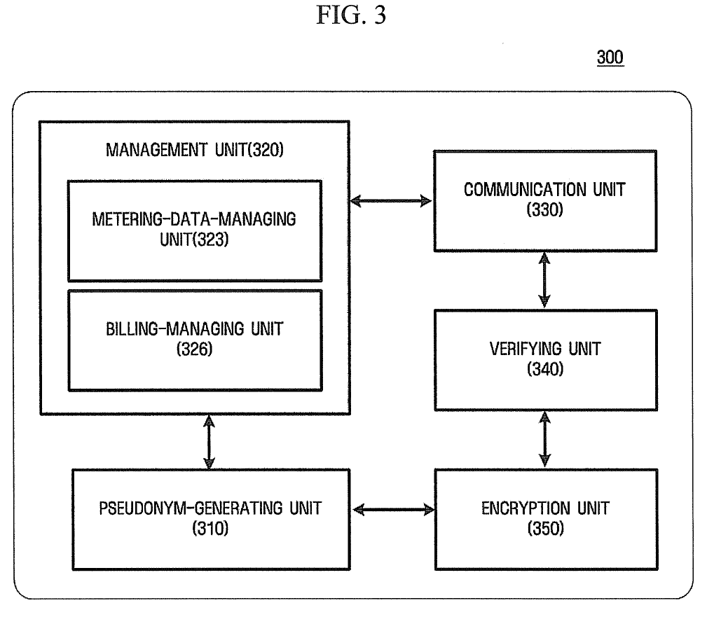

FIG. 3 is a block diagram of a personal-information-protecting apparatus according to aspects of the present invention. While not required in all aspects, a personal-information-protecting apparatus 300 can be embodied as a personal device, such as a personal computer, or a portable device such as a personal digital assistant, portable media player, a cell phone, and/or a cellular camera phone. The personal-information-protecting apparatus 300 is hereinafter referred to as a “device”. The device 300 includes a pseudonym-generating unit 310, a management unit 320, a communication unit 330, a verifying unit 340, and an encryption unit 350.

The pseudonym-generating unit 310 generates and manages a pseudonym, a pseudo-public key, and a pseudo-secret key. The pseudonym-generating unit 310 generates the pseudo-public key and the pseudo-secret key to correspond to the generated pseudonym. The pseudonym-generating unit 310 generates a message blinding the pseudonym and a signature value of the message using the pair of the pseudo-public and the pseudo secret keys, and transmits the signature value to a pseudonym credential issuer (not shown) via the communication unit 330. The pseudonym-generating unit 310 may generate multiple pseudonyms, pseudo-public keys, and pseudo-secret keys so as to further protect personal information. The pseudonym generated and managed by the pseudonym-generating unit 310 is a device ID that is hidden from the devices with which the device 300 communicates, i.e., a fake name. The pseudonym may be a random set of characters of a predetermined length, a binary string, a hash of the actual device ID, or any other identifier that does not disclose the true identity of the device 300. The pseudo-public key and the pseudo-secret key are public and secret (or private) keys associated with the pseudonym.

The management unit 320 manages at least one of metering data corresponding to the pseudonym and billing information corresponding to the metering data. Therefore, the management unit 320 includes a metering-data-managing unit 323 and a billing-managing unit 326. As such, the management unit 320 is not limited thereto. The management unit 320 may manage both the metering data and the billing information, or the management unit 320 may include additional units to manage other aspects of data associated with the user, such as file histories or favorites. The management unit 320 is implemented in the device 300 and stores and manages the metering data and the billing information.

The metering-data-managing unit 323 stores and manages metering data corresponding to the pseudonym. The metering data includes information regarding content type and content use. If the metering-data-managing unit 323 knows that a payment for the content use has been paid via the communication unit 330, the metering-data-managing unit 323 initializes the stored metering data. The metering-data-managing unit 323 can initialize the metering data corresponding to the paid content, or the metering-data-managing unit 323 can initialize the metering data corresponding to content for which payment is expected or to be billed. Examples of content include software, images, videos, audio data, digital books, sensitive research, text messages or like content used by a user.

The billing-managing unit 326 stores and manages billing information corresponding to the metering data. The billing-managing unit 326 requests the billing information by transmitting the metering data from the rights issuer (not shown) via the communication unit 330. The rights issuer generates billing information according to the content type and the content use, among others, included in the metering data, and transmits the information to the billing-managing unit 326. Such transmission can be via wired and/or wireless networks or aspects of the invention.

The billing-managing unit 326 performs a process of securing payment for the content type and the content use using the billing information via the communication unit 330. If the billing-managing unit 326 knows that a payment for the content type and the content use is paid via a communication unit 330, the billing-managing unit 326 initializes the stored billing information. The billing-managing unit 326 can initialize the billing information corresponding to the paid content, or the billing-managing unit 326 can initialize the billing information corresponding to content for which payment is expected or to be billed. Although the billing-managing unit 326 is described as securing payment for the content type and the content use, the billing-managing unit 326 is not limited thereto. The billing-managing unit 326 may secure payment based on only the content type or the content use, or the billing-managing unit 326 may secure payment based on subscription memberships or any other acceptable system of payment.

The communication unit 330 communicates with the pseudonym credential issuer 400, a payment center 401, the rights issuer 500, etc. For example, the communication unit 330 requests a pseudonym credential from the pseudonym credential issuer 400 or a rights object according to a pseudonym authentication from the rights issuer 500. The communication unit 330 transmits metering data to the rights issuer 500, and receives billing information for the content type and the content use from the rights issuer 500. The communication unit 330 notifies a payment center 401 regarding the content type and content use or receives a response message indicating payment completion. Payment completion depends upon the business model associated with the use of the described invention in that a content provider may choose to consider payment complete when the customer is billed or when the customer actually pays. Further, different customers may be treated differently based on past payment history, among other things.

The verifying unit 340 verifies that the pseudonym included in the rights object bound to the pseudonym is identical to one of the pseudonyms generated by the pseudonym-generating unit 310. The rights object is received from the rights issuer 500 via the communication unit 330. The rights object includes information on a permission and a constraint regarding the predetermined or selected content. The rights object also includes a rights key that can decrypt the encrypted content using the pseudo-public key. The verifying unit 340 further verifies that the pseudonym credential transmitted from the rights issuer 500 is valid. If the pseudonym is identical to one of the generated pseudonyms and the pseudonym credential is valid, the verifying unit 340 decrypts the encrypted content transmitted from the rights issuer 500 via an encryption unit 350 using the pseudo-secret key generated by the pseudonym-generating unit 310, thereby allowing the device 300 to use the decrypted content.

The encryption unit 350 encrypts information (pseudonym, pseudo-public key, and pseudo-secret key) generated via the pseudonym-generating unit 310. The encryption is to prevent the generated information from being abnormally deleted, changed, and/or copied. The encryption unit 350 can decrypt the encrypted content transmitted from the rights issuer 500 using the pseudo-secret key generated by the pseudonym-generating unit 310. The encryption unit 350 encrypts and decrypts predetermined data in the device 300.

The term “unit”, as used herein, means, but is not limited to, a software or hardware component, such as a Field Programmable Gate Array (FPGA) or an Application Specific Integrated Circuit (ASIC), which performs certain tasks. A module may advantageously be configured to reside in the addressable storage medium and configured to execute on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules.

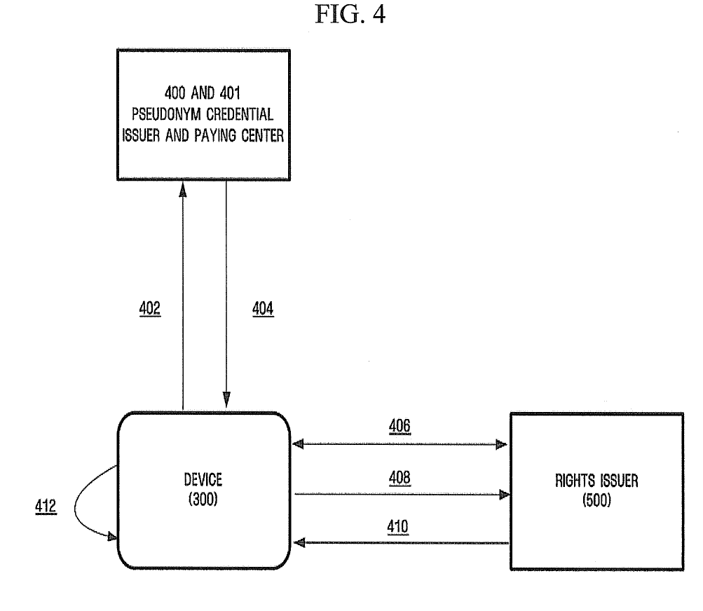

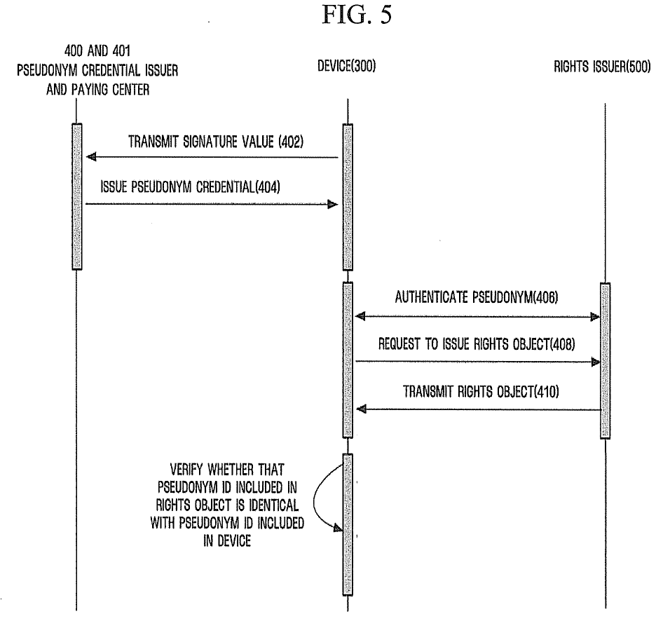

FIGS. 4 and 5 depict a process of issuing a rights object according to aspects of the present invention. FIGS. 4 and 5 depicts that the device 300 receives a pseudonym credential from a pseudonym credential issuer 400 using a pseudonym and a pair of keys corresponding to the pseudonym. Then the device 300 receives a rights object corresponding to the pseudonym from the rights issuer 500 using the issued pseudonym credential.

Specifically, the device 300 generates a pseudonym via the pseudonym-generating unit 310, a pseudo-public key (N, e) and a pseudo-secret key (N, d). The pseudo-public key and the pseudo-secret key correspond to the pseudonym. The device 300 encrypts the generated information via the encryption unit 350. The encryption is to prevent the generated information from being abnormally deleted, changed, and/or copied. However, it is understood that encryption need not be performed in all aspects.

In operation 402, the device 300 generates a message M blinding the pseudonym, generates a signature value for the generated message using the pair of keys, and transmits the generated signature value to the pseudonym credential issuer 400. The device 300 calculates M to be equal to Hash (pseudo-public key and pseudonym) using a pseudo-public key (Pseudo_pk), and generates M′ to be equal to Mr^{d} using an optional value r and a secret exponent d. The M is obtained by hashing the pseudonym and the pseudo-public key. The device 300 generates the signature value for M′ to equal Signature (pseudo-secret key, M′) using the pseudo-secret key (Dev_sk), and transmits the signature value to the pseudonym credential issuer 400. That is, the signature value includes a blinded pseudonym bound by the pseudo-public key.

In operation 404, the pseudonym credential issuer 400 verifies the signature value transmitted from the device 300, and issues a first pseudonym credential if the verified signature value is valid. Preferably, the first pseudonym credential (PC′) can be obtained such that PC′=Signature (pseudo-secret key of the pseudonym credential issuer 400 and M′).

The device 300 restores a signature for M using a second pseudonym credential issued by the pseudonym credential issuer 400, i.e., a second pseudonym credential (PC), which refers to converting the second pseudonym credential into a signature for M because the first pseudonym credential issued by the pseudonym credential issuer 400 is a signature for M′ i.e., PC′=M′^{d}=M^{d}*(r^{e})^{d}=M^{d}*r, and PC′/r=M^{d}=PC.

In operation 406, when the device 300 requests an authentication for the pseudonym via the pseudonym credential, the rights issuer 500 performs a pseudonym authentication to verify the validity of the pseudonym credential in response to the request. When the first pseudonym is used, the rights issuer 500 is initialized for collecting data corresponding to the pseudonym. That is, a storage space is generated for storing information on a pseudonym credential for the first pseudonym, a pseudonym, and a time through the initialization. The rights issuer 500 verifies whether the pseudonym credential is valid using the public key of the pseudonym credential issuer 400. That is, the pseudonym credential is verified when Verify (public key of the pseudonym credential issuer 400, pseudonym credential) is 1.

In operation 408, when the authentication by the rights issuer 500 is completed, the device 300 requests a rights object including information that enables the device 300 to use the content from the rights issuer 500.

In operation 410, the rights issuer 500 generates a rights object bound to the pseudonym, and transmits the rights object to the device 300. At this time, the key enables the device 300 to decrypt the encrypted content using the pseudo-public key, which is included in the rights object.

In operation 412, the device 300 verifies whether a pseudonym ID included in the rights object is identical to one of the pseudonyms stored in the pseudonym-generating unit 310 (i.e., the device 300 compares the pseudonym ID and the pseudonyms generated in the device 300 and determines whether the pseudonym credential is valid). If the pseudonym is identical and the pseudonym credential is valid, it is possible to obtain a secret key that can decrypt the encrypted content and to use the content using the pseudo-secret key generated by the pseudonym-generating unit 310.

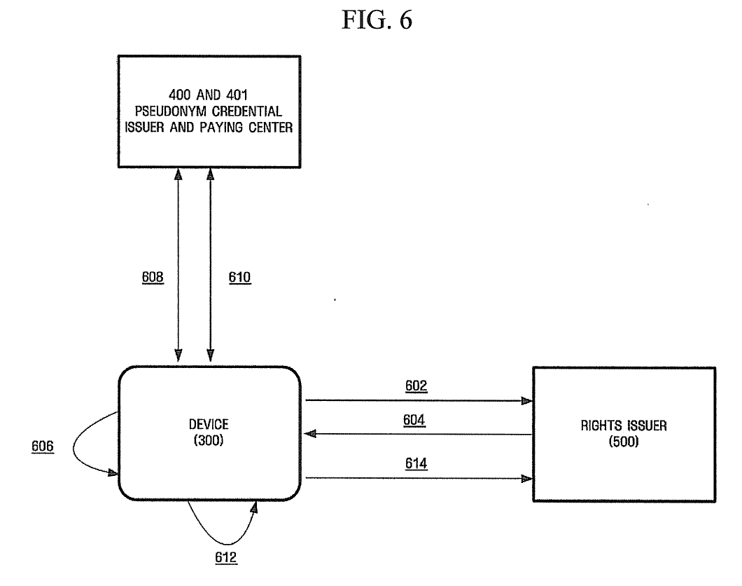

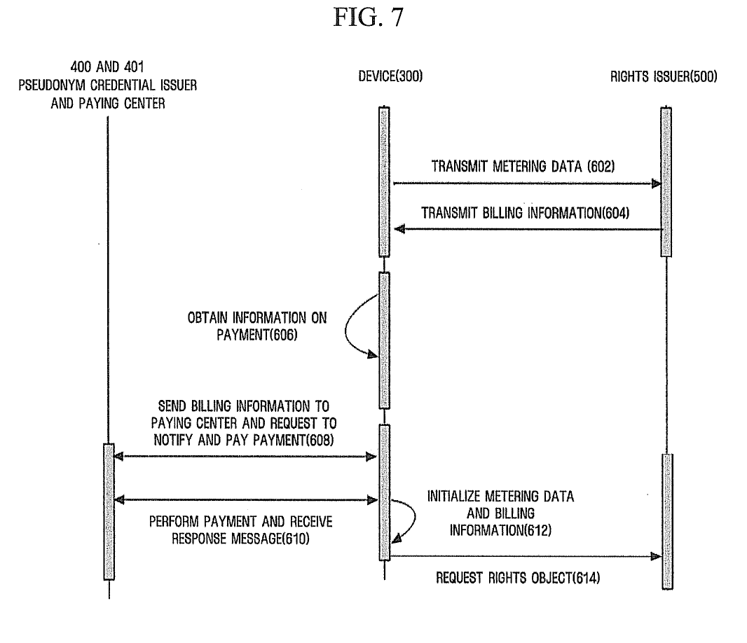

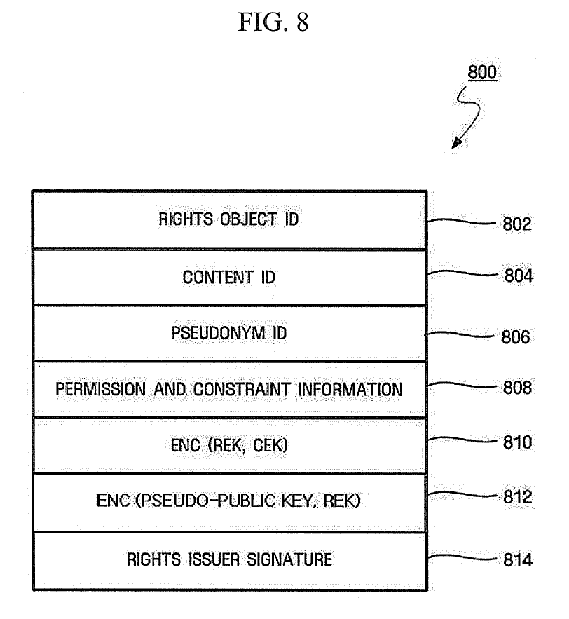

Operations for initializing billing information and metering data will be described with reference to FIGS. 6 and 7. The structure of the rights object will be described with reference to FIG. 8. FIGS. 6 and 7 depict a process of initializing metering data and billing information according to aspects of the present invention.

FIGS. 6 and 7 illustrate that the device 300 notifies the rights issuer 500 as to metering data including information on a type of the used content and content use, the rights issuer 500 issues billing information, and the device 300 secures a payment via the payment-managing-server using the issued billing information. The device 300 then initializes metering data and billing information.

In operation 602, the device 300 transmits metering data including information on type of the content corresponding to the pseudonym and content use to the rights issuer 500, (i.e., a metering data report).

After transmitting the metering data report, the device 300 requests billing information for its device ID. The billing information for a pseudonym may be issued at this point. The device ID is hidden through a blind signature. That is, when a public key of the rights issuer 500 is (N′, e′), the device 300 transmits X, defined as Hash (device ID)/r^{e′}. The X is a message blinded in order to obtain a signature for the device ID.

In operation 604, the rights issuer 500 calculates billing information using its secret key (N′, d′), and transmits the billing information to the device 300. The billing information can be represented as Y which is equal to {X*Hash (payment, time-stamp)}^{d′}.

In operation 606, the device 300 obtains information on the payment for the content use and the content type allocated to the device ID by receiving the billing information, and stores the information in the billing-managing unit 326. Preferably, a payment for the content use and/or the allocated to the device ID can be restored using Y/r={Hash(UID)*Hash (payment, time-stamp)}d′. However, other mechanisms can be used.

In operation 608, the device 300 sends the billing information including information on a payment to the paying center 401. The paying center 401 checks the transmitted billing information and requests a payment for the content use and/or content type.

In operation 610, the device 300 pays the payment to the paying center 401, and receives a response message for the payment completion of the paying center 401. However, the device is not limited thereto such that the payment paid to the paying center 401 may a promise to pay, a subscription membership, a gift certificate or other credit, or may be a request that a bill be charged to an account, etc.

In operation 612, the device 300 initializes the stored metering data and billing information. Preferably, the device 300 initializes only the billing information for the paid content and the metering data, not all information, because the device 300 may manage metering data and billing information corresponding to each of several pseudonyms.

In operation 614, if metering data and billing information were initialized via a payment protocol, the device 300 may request a rights object from the rights issuer 500 corresponding to a pseudonym. According to some aspects of the invention, if the device 300 does not secure a payment for the content use, the device 300 may be barred from using new content or content types. As such, the device 300 could be prevented from illegally using the content.

FIG. 8 depicts the structure of a rights object bound to pseudonym according to aspects of the present invention. The rights object includes a rights object ID 802, a content ID 804 of content desired by the device 300, a pseudonym ID 806, and permission and constraint information 808. The information 808 includes limitations on a number of users, a use period, and the number of playing times. However, the information 808 may further include other digital rights management tools, such as territorial restrictions or limitations on backing up received content, or only include one of the above-described limitations.

The rights object includes information 810 on a first key (CEK), which encrypts the content. The information 810 on the first key (CEK) is encrypted by a second key (REK), and information 812 on the second key (REK) is encrypted by the pseudo-public key. Accordingly, the device 300, which has received a rights object from the rights issuer 500, uses the pseudo-secret key to decrypt the information 812 on the second key (REK). The device 300 then uses the information 812 on the second key (REK) to decrypt the information 810 on the first key (CEK). The device 300 can then use the information 810 on the first key (CEK) to decrypt the content so that the content may be used by the device 300. The structure of the rights object can be modified according to different use.

As described above, the method and apparatus for protecting personal information according to aspects of the present invention produce one or more of the following and other effects: It is possible to prevent personal information from being exposed by using a pseudonym, pseudo-public key, and pseudo-private key. Content providers can secure profits corresponding to the content use and/or the type of content used, and privacy of the user and device 300 can be maintained, thereby efficiently providing services.

Although a few embodiments of the present invention have been shown and described, it would be appreciated by those skilled in the art that changes may be made in this embodiment without departing from the principles and spirit of the invention, the scope of which is defined in the claims and their equivalents. For example, the functionality provided for in the components and modules may be combined into fewer components and modules or further separated into additional components and modules.

What is claimed is:

1. A personal-information-protecting apparatus of a device to protect personal information, the apparatus comprising:
a pseudonym-generating unit that generates a pseudonym to blind an ID of the device using content, a pseudo-public key, and a pseudo-secret key; and
a verifying unit that verifies whether a pseudonym included in a rights object is identical to the generated pseudonym so as to selectively enable the device to use the content consistent with the rights indicated in the rights object,
wherein the pseudo-public key and the pseudo-secret key both correspond to the pseudonym.

2. The apparatus of claim 1, further comprising:
a metering-data-managing unit that stores and manages metering data corresponding to the generated pseudonym.

3. The apparatus of claim 2, wherein the metering data comprises information on a content type and a content use.

4. The apparatus of claim 3, wherein the metering-data-managing unit initializes the metering data corresponding to the pseudonym if a payment for the content use is completed.

5. The apparatus of claim 1, further comprising:
a billing-managing unit that stores and manages billing information for the content use.

6. The apparatus of claim 5, wherein the billing information corresponds to an ID of the device which is blinded by the generated pseudonym.

7. The apparatus of claim 5, wherein the billing information corresponds to the generated pseudonym.

8. The apparatus of claim 5, wherein the billing-managing unit initializes the metering data corresponding to the pseudonym if a payment for the content use is completed.

9. The apparatus of claim 1, wherein the rights object comprises information on a permission and a constraint corresponding to predetermined content.

10. A personal-information-protecting method, comprising:
generating a pseudonym to blind an identity of a device that uses content;
generating a pseudo-public key to correspond to the pseudonym;
generating a pseudo-secret key to correspond to the pseudonym; and
verifying that a pseudonym included in a rights object is identical to one of the generated pseudonyms so as to selectively allow use of the content according to rights indicated in the rights object.

11. The method of claim 10, further comprising:
storing and managing metering data corresponding to the generated pseudonym.

12. The method of claim 11, wherein the metering data comprises information on a content type and a content use.

13. The method of claim 12, wherein the managing of the metering data comprises initializing the metering data corresponding to the pseudonym if a payment for the content use is completed.

14. The method of claim 10, further comprising:
storing and managing billing information for the content use.

15. The method of claim 14, wherein the billing information corresponds to the generated pseudonym.

16. The method of claim 14, wherein the managing of the billing information comprises initializing the metering data corresponding to the used pseudonym if a payment for the content use is completed.

17. The method of claim 10, wherein the rights object comprises information on a permission and a constraint of predetermined content.

18. The apparatus of claim 1, wherein the device transmits to a pseudonym credential issuer a request for a pseudonym credential for a signature value, and the device receives from the pseudonym credential issuer a pseudonym credential if the signature value is valid.

19. The apparatus of claim 18, wherein the signature value comprises the pseudonym blinded and bound by the pseudo-public key.

20. The apparatus of claim 18, wherein the signature value is equal to the signature of the pseudo-secret key and M′, wherein M′ is an exponentiated hash of the pseudonym and the pseudo-public key.

21. The apparatus of claim 20, wherein M′ is exponentiated with a secret exponent d.

22. The apparatus of claim 1, wherein the pseudonym-generating unit generates a plurality of pseudonyms, and the verifying unit verifies whether the pseudonym included in the rights object is identical to one of the generated pseudonyms.

23. The method of claim 11, wherein a rights issuer issues the rights object to a device, and the device stores and manages the metering data.

24. The method of claim 14, wherein a rights issuer issues the rights object to a device, and the device stores and manages the billing information.

25. A system for protecting personal information, comprising:
a device that uses content and generates a pseudonym to mask an ID of the device, a pseudo-public key, and a pseudo-secret key;
a rights issuer to generate a rights object including information that enables the device to use the content; and
a pseudonym credential issuer to verify the device,
wherein the device generates a signature value from the pseudonym and the pseudo-public key, the pseudonym credential issuer verifies the signature value, and the rights issuer transmits the rights object to the device according to the verified signature.

26. The system of claim 25, further comprising:
a paying center to accept a payment from the device,
wherein the device transmits a metering data to the rights issuer, the rights issuer transmits billing information to the device in response thereto, the device transmits the billing information to the paying center that certifies the payment, and the device requests the rights object from the rights issuer according to the certified payment.

27. The system of claim 25, wherein the further rights object authenticates the verified signature with the pseudo-public key.

28. The system of claim 25, wherein the device generates a plurality of pseudonyms.
